(19) United States
(12) Patent Application Publication
(10) Pub. No.: US 2004/0032058 A1
(43) Pub. Date: Feb. 19, 2004

(54) Systems and methods for casting and handling assay matrices

(76) Inventors: Robert K. Neeper, Lakeside, CA (US); Rhett L. Affleck, Poway, CA (US); John E. Lillig, Poway, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/219,081

(22) Filed: Aug. 13, 2002

(51) Int. Cl. C08J 5/00; C02F 1/469; B29C 45/00

(52) U.S. Cl. 264/328.1; 204/461; 264/331.16; 425/174; 425/542

(57) ABSTRACT

Disclosed are systems and methods for casting, handling, or storing assay matrices. In one embodiment, an assay matrix casting system comprises a gel matrix frame sandwiched between two films, forming a “gel matrix mold,” two plates sandwiching the gel matrix mold, one or more devices for delivering gel material into a chamber formed by the gel matrix mold, and a device for pressing the plates toward each other. An assay matrix is cast by applying pressure to the, injecting a liquid gel material into the chamber of the gel matrix mold, and allowing the gel material to form a gel matrix inside the chamber. The gel matrix may be handled or stored using the gel matrix mold, which is removable from the other components of the gel casting system.

### BACKGROUND OF THE INVENTION

1. Technical Field

The invention relates generally to the field of biochemical or biological assaying. More particularly, the invention concerns systems and methods for casting, handling, and storing assay matrices.

2. Description of the Related Art

Modern drug discovery technology gives rise to a need for systems and methods to test, or “screen,” large numbers of chemical agents to ascertain their biological or biochemical activities. Screening of chemical agents has evolved from mostly one-at-time assays requiring days or weeks to perform, to manual and semi-automated systems that yielded a few assay data points per day (“low throughput” systems), to highly automated systems that by incorporating miniaturization are capable of producing thousands or even hundreds of thousands (“high throughput” or “ultra-high throughput”) of data points per day. High throughput screening (“HTS”) is typically performed using well known microtitre plate techniques.

As discussed in U.S. Pat. No. 5,976,813 to Beutel et al. (“Beutel”), efforts aimed at increasing screening throughput have mainly focused on increasing miniaturization of the wells of microtitre plates. However, miniaturization of the wells is quickly approaching physical and manufacturing limitations, and increasing well miniaturization brings with it increasing costs and complexities. Beutel describes a Continuous-Format High Throughput Screening (CF-HTS) system that replaces microtitre-plate-based HTS. In general terms, CF-HTS uses porous assay matrices carrying reagents to test large numbers of candidate chemical agents brought into contact with the porous assay matrices. The chemical agents may also be carried on porous or nonporous substrates.

As used here, “substrate” generally describes any matrix, porous or nonporous, suitable for carrying chemical, biochemical, or biological agents. For example, a substrate may be a gel, a membrane, or a solid or semi-solid matrix. As used here, “assay matrix” refers to a substrate that may be used in performing an assay. An example of an assay matrix is a gel matrix made of agarose, such as those “gels” well known in performing gel assays for antibacterial or anticancer agents and the familiar immunological assays where an antigen or antibody interaction is performed and measured in a gel. Gel assays typically involve the casting of a gel matrix in a petri dish or similar container. A gel material, e.g., agarose or polyacrylamide, is poured into the petri dish and allowed to set, thereby forming a gel matrix.

The use of gel matrices is also well known in the field of gel electrophoresis, where the gel matrix is usually used to separate molecular components (e.g., proteins and nucleic acids) having different mobilities in a porous medium under the action of an electric potential. Gel matrices for use in gel electrophoresis are usually cast by pouring, and allowing to set, a gel material between two plates that are separated by longitudinal spacers. A drawback to this method of casting a gel matrix is that as the gap between the plates is made smaller the viscosity and surface tension of the gel material act to prevent the gel material from entering the space between the two plates. This gives rise to a constraint on the minimum thickness of the gel matrix that may be cast with the two-plate-spacers assembly. The combination of plates and spacers is sometimes referred to in the relevant technology as a “cassette.” Typically, electrophoresis is carried out by placing the cassette into an electrophoresis apparatus that is configured to receive the cassette and apply a voltage potential to the gel matrix.

The known methods of casting, handling, and storing gel matrices are not optimal for use in conjunction with new HTS techniques such as CF-HTS. For example, in CF-HTS a gel containing assay reagents is mated with a substrate carrying a library of test compounds, which diffuse into the gel and produce a readable result if a desired activity is present. Hence, for CF-HTS sometimes it is desirable to provide systems to cast gel matrices that are relatively thinner than gel matrices cast using petri dishes, or similar containers, or electrophoresis-type cassettes. The industry further needs systems and methods for casting gel matrices that are substantially flexible and of even thickness.

There is also a need in the field for systems and methods that allow for convenient manipulation and storage of the gel matrix without damaging it. The industry needs systems and methods for handling assay matrices without causing distortions of the assay matrix on the plane of the assay matrix. Systems and methods are needed that allow some degree of bending of an assay matrix along its transverse axis. There is a further need for systems and methods that allow assay matrices, such as gel slabs for example, to be exposed on one or more surfaces for directly contacting one or more surfaces of the gel slabs with other matrices, substrates, membranes, etc.

### SUMMARY OF THE INVENTION

The systems and methods disclosed here for casting, handling, and storing assay matrices meet the above and other needs in the industry. Embodiments of the invention described below have several aspects, no single one of which is solely responsible for desirable attributes of the inventive systems and methods. Without limiting the scope of this invention as expressed by the claims which follow, its more prominent features will now be discussed briefly.

One aspect of the invention concerns a system for casting an assay matrix. The system may comprise two plates positioned substantially parallel to one another for receiving in between the plates a mold for casting the assay matrix. The mold comprises a frame having a first side and a second side, at least one film that covers a side of the frame, or a first film that covers the first side of the frame and a second film that covers the second side of the frame. The mold forms at least part of a chamber for receiving a material for casting the assay matrix. The system further comprises a passageway into the chamber that is suitable for introducing into the chamber the material for casting the gel. The system is further configured such that the mold is removable from the plates.

Another feature of the invention is directed to a method of making an assay matrix. The method comprises providing two substantially parallel plates and an assay matrix casting mold, the mold comprising a frame placed between two films. The mold preferably forms at least part of a chamber for receiving a material for casting the assay matrix. The method further comprises placing the mold between the two plates, wherein the mold is removable from the plates. The method further comprises providing a passageway into the chamber that is suitable for introducing into the chamber the gel material. The method may further comprise introducing the gel material into the chamber.

In one embodiment, the invention relates to an apparatus for aiding in the casting and handling of an assay matrix, where plates are used for casting of the assay matrix. The apparatus may comprise a frame, having a plurality of inner and outer walls, positioned between two films; the plurality of inner walls and the two films may be configured to form a chamber for receiving a material for casting an assay matrix. The apparatus may further comprise a passageway into the chamber for injection of the material. The apparatus may be configured such that the frame is removable from the plates.

Yet another aspect of the invention concerns a system for performing an assay. The system comprises an assay matrix assembly having a gel slab laterally bounded by a frame and covered on at least a top side or a bottom side by a removable film. The system further comprises a planar substrate substantially sized and shaped to mate with the assay matrix assembly upon removal of the film such that diffusion of at least one assay agent can take place between the gel slab and the planar substrate.

### BRIEF DESCRIPTION OF THE DRAWINGS

The “Detailed Description of Certain Inventive Embodiments” section presented below should be read in conjunction with the accompanying drawings, in which:

FIG. 1 is a schematic diagram of a system for casting an assay matrix.

FIG. 2 is a perspective, exploded view of an assembly for casting an assay matrix and which may be used with the system shown in FIG. 1.

FIG. 3 is a perspective, exploded view of an assay matrix mold that may be used with system shown in FIG. 1.

FIG. 4 is an assembly view of a system for casting an assay matrix.

FIG. 5 is a perspective assembly view of the assay matrix mold, shown in FIG. 3, illustrating its use for handling and/or storage of an assay matrix.

FIGS. 6 through 13 depict examples of handling an assay matrix with the assay matrix mold shown in FIG. 5. FIG. 6 is a schematic diagram depicting the removal of a first film from an assay matrix mold holding an assay matrix.

FIG. 7 is a schematic diagram illustrating the use of the assay matrix mold, shown in FIG. 6, for placing an assay matrix upon a substrate.

FIG. 8 is a schematic diagram showing the removal of a second film from the assay matrix mold shown in FIG. 6.

FIG. 9 is a plan view of an assay matrix mold holding an assay matrix on top of a substrate, with one side of the assay matrix exposed.

FIG. 10 is a schematic diagram depicting an assay matrix upon a substrate, after the assay matrix frame shown in FIGS. 6 through 10 has been removed.

FIG. 11 is a schematic diagram illustrating the placement of an assay matrix frame and a first film on an assay matrix resting on a substrate.

FIG. 12 is a schematic diagram showing the placement of a second film on the assay matrix frame shown in FIG. 11.

FIG. 13 is a schematic diagram depicting use of an assay matrix mold for placing a first assay matrix upon a second assay matrix.

FIG. 14 is a schematic diagram illustrating interaction of multiple assay matrices handled with an assay matrix frame.

FIG. 15A is a plan view of one embodiment of an assay matrix frame.

FIG. 15B is a plan view depicting an alternative embodiment of an assay matrix frame.

FIG. 15C is a plan view illustrating another embodiment of an assay matrix frame.

FIG. 15D is a plan view showing an alternative embodiment of an assay matrix frame.

### DETAILED DESCRIPTION OF CERTAIN INVENTIVE EMBODIMENTS

The following detailed description is directed to certain specific embodiments of the invention. However, the invention can be embodied in a multitude of different ways as defined and covered by the claims. In this description, reference is made to the drawings wherein like parts are designated with like numerals throughout.

The inventive systems and methods described below facilitate the casting and handling of assay matrices which are typically used in performing chemical or biological assays. Briefly, in one embodiment the invention consists of a system for casting a gel matrix, for example. The system comprises a gel matrix frame sandwiched between two films, forming a “gel matrix mold,” two plates sandwiching the gel matrix mold, one or more devices for delivering gel material into a chamber formed by the gel matrix mold, and a device for pressing the two plates toward each other. In one embodiment a gel is cast by applying pressure to the two plates, injecting a gel material into the chamber of the gel matrix mold, and allowing the gel material to form a gel matrix inside the chamber. The gel may be handled or stored using the gel matrix mold, which is removable from the other components of the gel casting system.

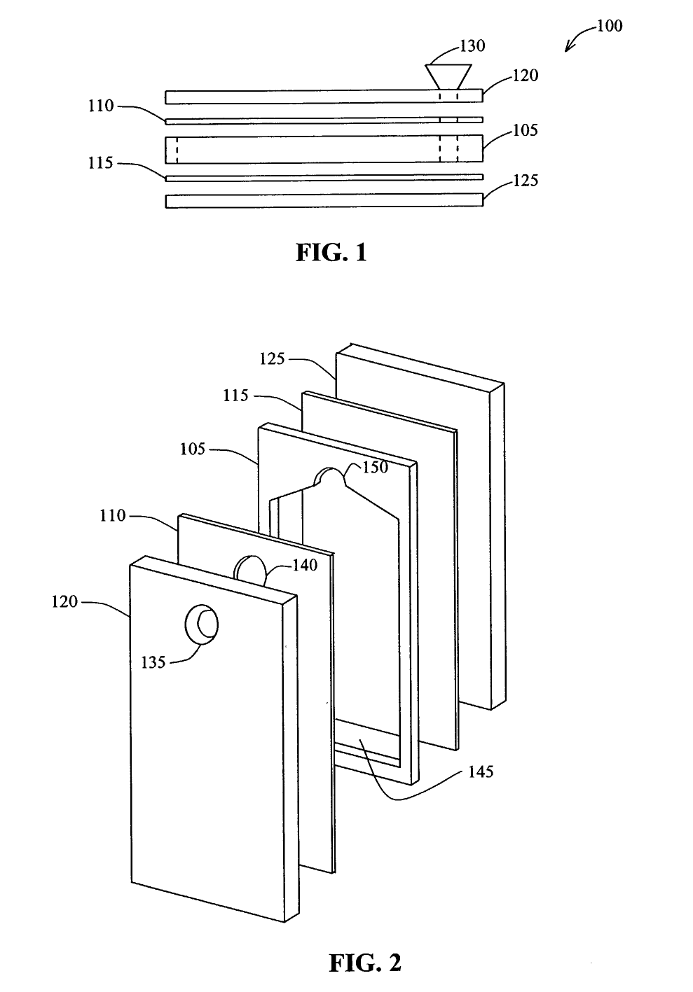

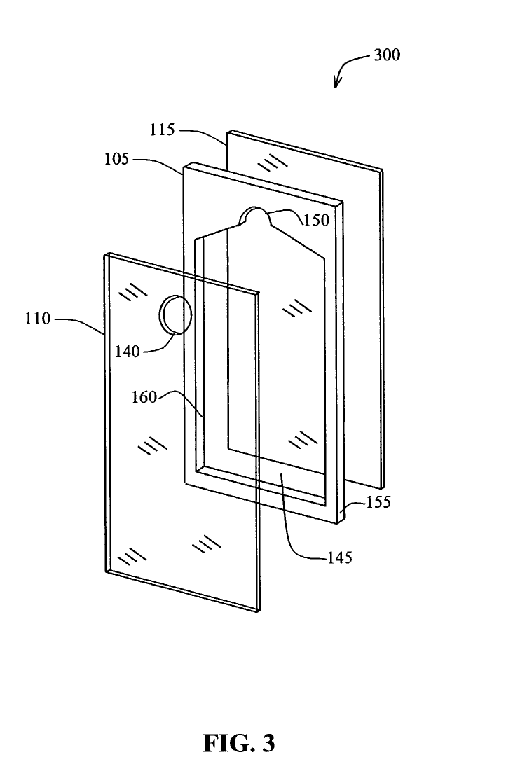

FIG. 1 depicts a system 100 for casting a gel matrix. The system 100 includes a gel matrix frame 105 positioned between a first film 110 and a second film 115. The gel matrix frame 105, the first film 110, and the second film 1 15 form a structure which will be referred to here as a gel matrix mold 300 (see FIG. 3). The system 100 further comprises a first plate 120 and a second plate 125, which are positioned such that the plate 120 is on one side of the gel matrix mold 300 and the plate 125 is on the other side of the gel matrix mold 300. In this embodiment, a guiding device 130 is attached to the plate 120 for introducing a gel material into a chamber 145 (see FIG. 2) formed by the gel matrix mold 300.

With reference to FIG. 2, the plate 120 is configured with an orifice 135 into which the guiding device 130 fits, or through which the gel material flows toward the chamber 145. The first film 110 has an orifice 140 collocated with the orifice 135. The gel matrix frame 105 is configured with an opening 150 that is substantially collocated with the orifice 140 for receiving the gel material flowing through orifices 135 and 140. The technician of ordinary skill in the relevant technology will readily recognize that the gel matrix frame 105 may be alternatively configured with an orifice in any convenient location along its edge for introducing the gel material into the chamber 145. This latter approach would not require that corresponding orifices be provided in the plate 120 or the first film 110.

The plates 120 and 125 are preferably made of a rigid, solid material such as glass or metal. Each of the plates 120 and 125 preferably has at least one surface that is substantially flat and suitable for applying even pressure to the gel matrix mold 300. In some embodiments of the system 100, the plate 120 is made of a material different from the material of the plate 125. For example, in the assembly shown in FIG. 2, the plate 120 may be made of glass, while the plate 125 may be made of aluminum. However, both plates 120 and 125 may be made of the same material. Each of the plates 120 and 125 may be supported by, or encased in, a suitable frame (not shown) to facilitate handling and protecting the plates 120 or 125.

Referring to FIG. 3, the gel matrix mold 300 may include a gel frame 105 sandwiched between a first film 110 and a second film 115. The first film 110 may be made of a thin, plastic film, which may be transparent (as indicated in FIG. 3 by the hatch lines and the see-through illustration of film 110). Suitable materials for the manufacture of the first film 110 include polymers such as polyvinyl chloride, polycarbonate, polystyrene, polyethylene, polyethylene terephthalate, and cellulose acetates or any of their copolymers. The film 110 is preferably less than 20 thousandths-of-an-inch (“mils”) thick, and more preferably less than 10 mils thick., and most preferably less than 3 mils thick.. To allow passage of the gel material into the chamber 145, the film 110 has an orifice 140. The second film 115 may be identical to the film 110 except that the second film 115 does not have an orifice. However, the film 115 may be made of a different material than the material of film 110. In one embodiment, the films 110 and 115 are made of a hydrophobic material. The films 110 and 115 removably adhere to a gel assay matrix 195 (see FIG. 5) due to the surface tension that develops between the films and the gel assay matrix 195. Thus, the films 110 and 115 remain attached to the gel assay matrix 195 but can be removed by “peeling” them off, i.e., applying to the film a relatively small force parallel to the face of the gel assay matrix 195.

The gel matrix frame 105 has outer walls 155 and inner walls 160, and is preferably made of a flexible plastic material that provides substantial rigidity to the structure in the plane of the gel matrix frame 105 to facilitate its handing and use. The gel matrix frame 105, however, may be sufficiently flexible enough to bend about its transverse axis (see FIG. 7). Suitable plastics for forming the gel matrix frame 105 include polymers such as polyethylene terephthalate, polyvinyl chloride, polycarbonate, polystyrene, polyethylene, and cellulose acetates or any of their copolymers. The inner walls 160 of the gel matrix frame 105 form part of a chamber 145, which is completely enclosed when the first film 110 and the second film 115 press against the frame 105, as when the plates 120 and 125 compress the gel matrix mold 300.

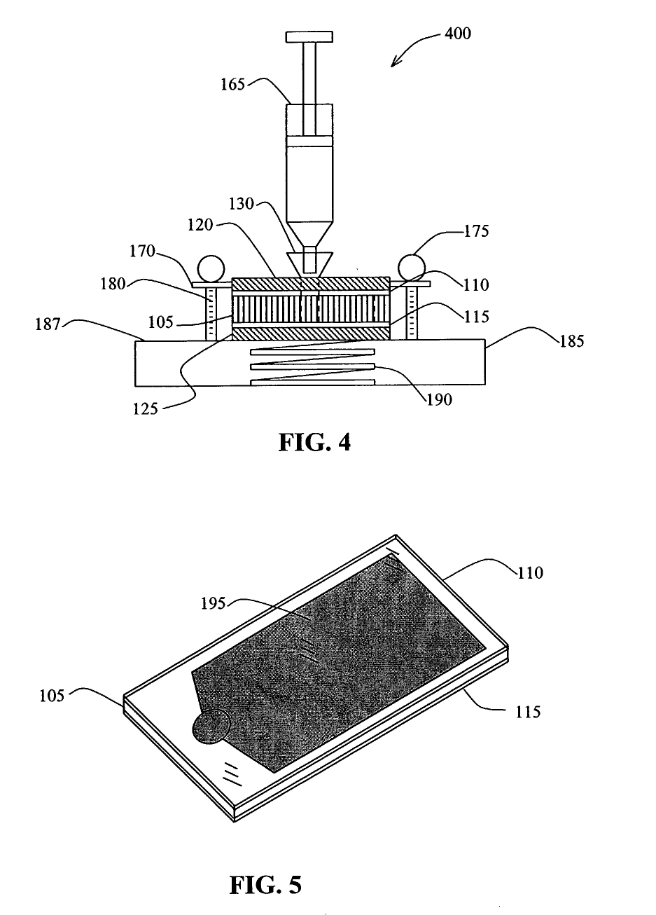

FIG. 4 is a schematic diagram of another embodiment of a system for casting a gel matrix according to the invention. The system 400 shown in FIG. 4 includes a casting assembly as previously discussed, namely a gel matrix mold 300 made of a gel frame 105 positioned between a first film 110 and a second film 115, two plates 120 and 125 sandwiching the gel matrix mold 300, and a guiding device 130. In this embodiment, plate 120 is configured with engagement members 170 for transmitting a compression force applied by arms 175. The arms 175 apply pressure to the plate 120 through manual or mechanical loading of springs 180, for example. The system 400 may also include a gel material delivery device 165 for introducing the gel material into the chamber 145 of the gel mold 300. As shown, the gel casting assembly may be supported by a platform 185, which may be configured with a heating/cooling coil 190.

The engagement members 170, the arms 175, and the springs 180 are well known mechanical components, and consequently there is no need to describe them in detail here. Briefly, however, the role of these mechanical components in the gel casting system 400 is to provide a clamping function such that the mechanical components compress plates 120 and 125 toward each other, and thereby also compress the first film 110 and the second film 115 against the gel frame 105. A person of ordinary skill in the relevant technology will readily recognize that there are various well known elements and means that may provide the clamping function. For example, the arms 175 may be suitably shaped metallic members that are acted upon by a magnetic device (not shown).

The gel material delivery device 165 may be any device configured for introducing the gel material into the guiding device 130, through the orifice 135 of plate 120, through the orifice 140 of the first film 110, and into the chamber 145. In some embodiments, when casting relatively thick gels for example, the gel material delivery device 165 delivers the gel material into the chamber 145 with the aid of gravity, i.e., no force other than that exerted by gravity on the gel material is needed. In these situations, the gel material delivery device 165 primarily functions to guide the gel material into the chamber 145. In other embodiments, however, the gel material delivery device 165 is preferably configured to apply a positive pressure to the gel material in order to avoid back drift of the gel material from the chamber 145 into the gel material delivery device 165. Additionally, pressurized delivery of the gel material overcomes the resistance of the viscosity and surface tension of the gel material to entering the chamber 145. The resistance increases as the thickness of the gel matrix frame 105 decreases and makes the chamber 145 thinner. Using pressure to inject the gel material into the chamber 145 overcomes the resistance and allows the use of a very thin gel matrix frame 105; consequently, it is possible to cast a very thin gel matrix. In the embodiment shown, the gel delivery device 165 consists of a syringe, which is device well known in the relevant technology. The syringe may be, for example, a 10-mL Norm-Ject syringe distributed by VWR Scientific Products, of So. Plainfiled, N.J., U.S.A., under part number 53548-006. In other embodiments, the gel delivery device 165 may be a pump working in conjunction with a check valve, for example. Additionally, the guiding device 130 may be made integral with the gel material delivery device 165, rather than being part of the plate 120.

The platform 185 may be any structure that provides a substantially flat and stable surface for supporting the gel casting assembly. The platform 185 may be, for example, a box made of metal, plastic, or any other suitable material, having a flat top which provides a base for the gel casting assembly. Depending on the clamping mechanism used, the platform 185 may be a table top, a laboratory bench, etc. In one embodiment, the platform 185 may have a metallic surface 187 that functionally replaces the plate 125. That is, the metallic surface 187 may also serve as a plate 125 that has been built into the platform 185.

The gel casting system 400 may include a platform 185 that is an enclosure for electronics, actuators, sensors, etc., that may be used in conjunction with the gel casting system 400. For example, as shown in FIG. 4, one embodiment of the gel casting system 400 comprises a heating/cooling coil 190 located in the platform 185. The heating/cooling coil 190 may be used to transfer heat to or cool the gel material, which is injected into and contained in the chamber 145, via the plate 125. It will be apparent to the technician of ordinary skill that the heating/cooling coil 190 need not be part of the platform 185, but instead could be directly integrated into a ceramic or metallic plate 125, for example. The heating/cooling coil 190 may be any suitable heating and/or cooling device, including a resistance heater, a fluid-carrying tube, or a peltier junction.

The invention as embodied in the systems described with reference to FIGS. 1 through 4 facilitate the quick and convenient casting of gel matrices. The casting of a gel matrix according to embodiments of the invention will now be described with particular reference to FIG. 4. A gel casting assembly such as that one used in the gel casting system 400 is put together. Preferably the thickness of the gel matrix frame 105 is chosen to produce the desired thickness of the gel matrix. Hence, the thinner the gel frame 105, the thinner the resulting gel matrix. To avoid excessive leakage of the gel material, the plates 120 and 125 are pressed, i.e., clamped, toward each other up to a suitable pressure level. For example, a pressure of about 500 kPa was found to be suitable for a gel matrix frame 105 presenting an effective pressure area of about 15-cm². The person of ordinary skill in the relevant technology will readily recognize that there are various possible combinations of effective force and effective pressure area that may be used to produce a pressure of about 500 kPa. The spring loaded arms 175 apply the compressive force to the plates 120 and 125. Additionally, even thickness of the gel matrix 195 (see FIG. 5) may be ensured by placing the plates 120 and 125 substantially parallel to one another and configuring the plates 120 and 125 with substantially flat and rigid surfaces that compress the gel matrix mold 300.

A gel material in substantially liquid form is injected with the gel material delivery device 165 into the chamber 145 (see FIG. 3). For example, it has been found that the pressures generated by hand using a syringe of about 16-mm inner-diameter are suitable for injection of a 2%-low-melt agarose gel material at a temperature of about 30 to 35° C. In one embodiment, the gel material is injected into the chamber 145 while the plate 125 is warm to prevent premature setting of the gel material. The chamber 145 is preferably not airtight so that air in the chamber 145 may be expelled out by the gel material injected into the chamber 145. Some of the gel material may seep into the interfaces between the gel frame 105, the first film 110, and the second film 115; however, the gel matrix mold 300 is sufficiently pressurized by the plates 120 and 125 such that there is no excessive leakage of the gel material from the gel matrix mold 300. Advantageously, the gel material that seeps between the gel frame 105 and the films 110 and 115 provides a seal against evaporation of liquid from the gel assay matrix 195.

The gel matrix mold 300 provides a chamber 145 where the gel material sets and forms a gel matrix. Cooling the gel material with the heating/cooling coil 190 may be used to rapidly cause the gel material to set, which makes the process of casting the gel matrix 195 relatively more time efficient when compared to the known matrix casting methods. Rapid setting of the gel material also facilitates, for example, the production of a substantially homogeneous gel matrix 195 having particles, such as living cells or beads carrying chemical agents, embedded in the gel matrix 195. Alternatively, the gel material may be injected into the chamber 145 and not cooled for some period of time. This has the effect of allowing the particles to settle on one of the surfaces of the gel matrix 195.

The casting of the gel matrix 195 while the plates 120 and 125 are positioned horizontally, along with the ability to heat/cool the gel material, allows the casting of a gel matrix 195 that has surfaces specifically configured for interaction of chemical agents, or measurement of activity, at short distances. For example, the gel matrix 195 may have cells located substantially on its surface so as to facilitate (i) interaction of the cells with a biosensor that requires short distance interaction, or (ii) activity between the cells and a large molecular weight bio/chemical material that diffuses slowly, or (iii) minimization of the lateral diffusion of chemical reagents.

After the gel matrix sets, the clamping devices (e.g., the arms 175) and the plate 120 are removed from the casting assembly to allow removal of the gel matrix mold 300 from the gel casting assembly, providing a gel matrix 195 within a gel matrix frame 105 that has first and second films 110 and 115 on its front and back sides respectively. The gel matrix 195 may be conveniently handled with or stored in the gel matrix mold 300, or alternatively may be removed for performing assays or storage in a different holder.

FIG. 5 shows a gel matrix mold 300 holding a gel matrix 195. As illustrated, the gel matrix frame 105 provides a space for forming and holding the gel matrix 195, and the first film 110 along with the second film 115 provide support on the longitudinal sides of the gel matrix 195 to keep the gel matrix 195 in place. To facilitate this function of the first film 110 and the second film 115, the first film 110, the second film 115, and the gel frame 105 may advantageously be made of materials that attract one another, such as permanently-charged electrostatic plastic materials. In one embodiment, at least one of the films 110 and 115 is removably attached to the gel frame 105 with a suitable adhesive. When casting a very thin gel matrix 195 it may be preferable to utilize films 110 and 115 that do not attract to each other, because on assembly of the gel matrix mold 300 the films 110 and 115 may come together and, consequently, not allow a chamber 145 to be formed.

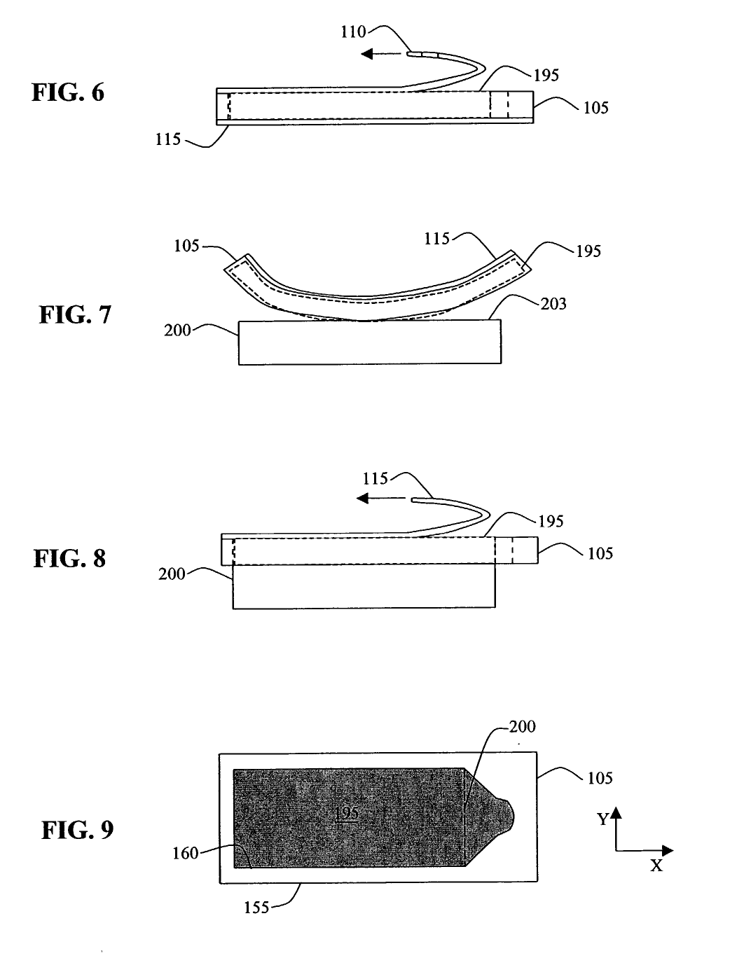

FIGS. 6 through 12 depict examples of the use of the gel matrix mold 300 for handling the gel matrix 195, which is shown in dashed lines to indicate that it is held within the gel matrix frame 105. FIG. 6 shows a side view of a gel matrix mold 300 holding a gel matrix 195, and the removal of the first film 110 from the gel matrix frame 105. The first film 110 is flexible and thin enough to allow an operator to bend the first film 110 substantially. This allows removal of the first film 110 from the gel matrix frame 105 and the gel matrix 195 without tearing or otherwise damaging the gel matrix 195.

As shown in FIG. 7, the gel matrix frame 105 may be positioned such that the exposed gel matrix 195 can be placed in contact with a substrate 200. The substrate 200 may be, for example, an assay matrix having an array of dried chemical compounds arrayed on a surface 203. The exposed surface(s) of the gel matrix 195 are brought into contact with the surface 203 to perform, an assay in which, for example, a portion of the chemical compounds on the surface 203 diffuse into the gel matrix 195. Of course, in some embodiments, the assay may involve diffusion from the substrate 200 into the gel matrix 195, and/or from the gel matrix 195 into the substrate 200. Hence, in some applications, for example those requiring diffusion, it is important that no air pockets form between the gel matrix 195 and the substrate 200. The gel matrix frame 105 in conjunction with a plastic film, either the first film 110 or the second film 115, provide a system for ensuring that the gel matrix 195 fully contacts the substrate 200 without gaps created by air pockets.

In one embodiment, avoiding air pockets is accomplished by bending the gel matrix frame 105 about its middle (i.e., its transverse axis), with the second plastic film 115 adhering to the gel matrix frame 105, and bringing the gel matrix 195 into contact with the substrate 200 at about the midportion of the substrate 200. The gel matrix frame 105 is configured such that it can bend, i.e., is flexible, about its transverse axis; however, the gel matrix frame 105 is preferably substantially rigid with respect to lateral forces applied in the plane of the gel matrix frame 105. Because the plastic film 115 removably adheres to the gel matrix 195, the plastic film 115 supports the gel matrix 195 in the position shown. From this position, the gel matrix 195 may then be spread out, i.e., laid out, on top of the substrate 200 in such a way that portions of the gel matrix 195 gradually come into contact with the substrate 200 without any air pockets being formed. Of course, the technician of ordinary skill will readily recognize that there are other ways in which the gel matrix frame 105 may be used to bring the gel matrix 195 into contact with the substrate 200. For example, instead of bringing the gel matrix 195 and the substrate 200 together at their respective midpoints, the gel matrix 195 and the substrate 200 could be brought together at their corresponding ends.

FIG. 8 shows the gel matrix frame 105 in its flat position, as well as the gel matrix 195 also positioned completely flat on top of the substrate 200. While the gel matrix frame is in this configuration, an operator may remove the second film 115 to expose the gel matrix 195 on its side opposite the side contacting the substrate 200. Alternatively, the second film 115 may be left in place if there is no need to expose that side of the gel matrix 195.

FIG. 9 is a plan view of the gel matrix frame 105 holding in place the gel matrix 195 on top of the substrate 200. As previously stated, the gel matrix frame 105 is preferably configured to be semi-rigid or substantially rigid on its plane, i.e., the x-y plane shown. The rigidity of the gel matrix frame 105 on the x-y plane may be provided by suitably chosen materials and the distance between the outer walls 155 and the inner walls 160, i.e., suitable thickness of the walls of the gel matrix frame 105. With reference to CF-HTS in particular, there are applications that use matrices in which one or more assay agents are spatially fixed. In these applications it is important that the gel matrix 195 is not spatially distorted in the x-y plane. Hence, the rigidity of the gel matrix frame 105 on the x-y plane is advantageous for CF-HTS assaying.

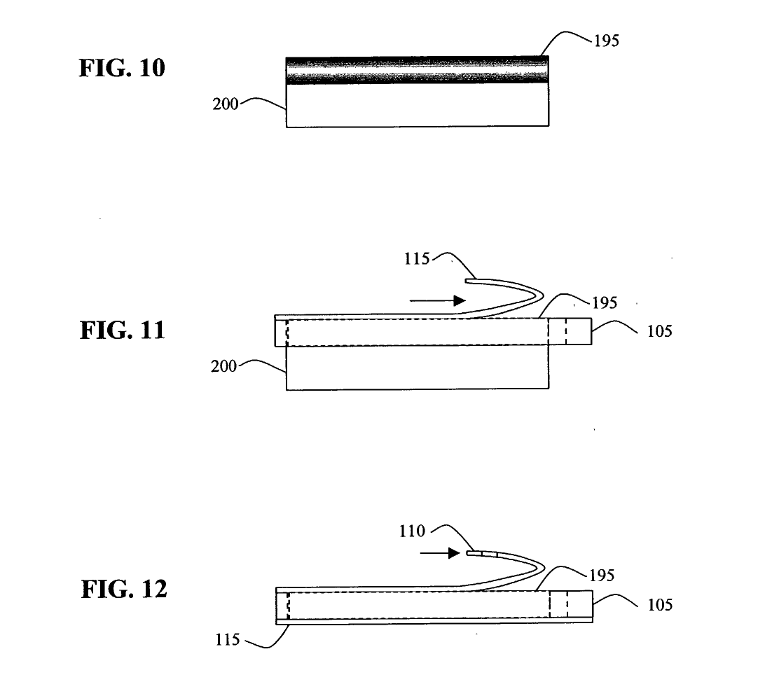

FIG. 10 illustrates a gel matrix 195 positioned on top of a substrate 200 after the gel matrix frame 105 has been removed. In some applications it may not be necessary, or even desirable, to remove the gel matrix frame 105; however, the configuration shown in FIG. 10 illustrates that the gel matrix 195 may be cast in a gel matrix mold 300, and may be completely removed from the gel matrix mold 300 efficiently and without causing damage to the gel matrix 195.

FIG. 11 and FIG. 12 show that the process described with reference to FIGS. 6 through 9 may be reversed such that the gel matrix 195 may be removed from the substrate 200 and placed back in the gel matrix mold 300. FIG. 11 illustrates the placing of a second film 115 over the gel matrix frame 105 and the gel matrix 195 positioned on top of a substrate 200. The second film 115 adheres to the gel matrix 195 and the gel matrix frame 105, and consequently, allows the gel matrix 195 to be pulled away from the substrate 200. As depicted in FIG. 12, the first film 110 (or optionally another film 115) may be placed on the other side of the gel matrix frame 105 to completely cover the gel matrix 195. Placing the gel matrix 195 back in the gel matrix mold 300 may be done for storage purposes, for example. The technician of ordinary skill will readily recognize that the gel matrix mold 300, as shown in FIG. 5, may be conveniently used for storing the gel matrix 195. The shelf life of a gel matrix 195 stored in gel matrix mold 300 will depend only on the constituents of the gel matrix 195, since the gel matrix frame 105 and the plastic films 110 and 115 may be made of environmentally stable materials.

The discussion involving FIGS. 4 through 12 has described the process of casting and handling the gel matrix 195 such that damage to the gel matrix 195 is avoided, no air pockets are formed between the gel matrix 195 and the substrate 200, both sides of the gel matrix 195 may be exposed to other matrices or substrates, and the gel matrix 195 may be stored after performance of an assay.

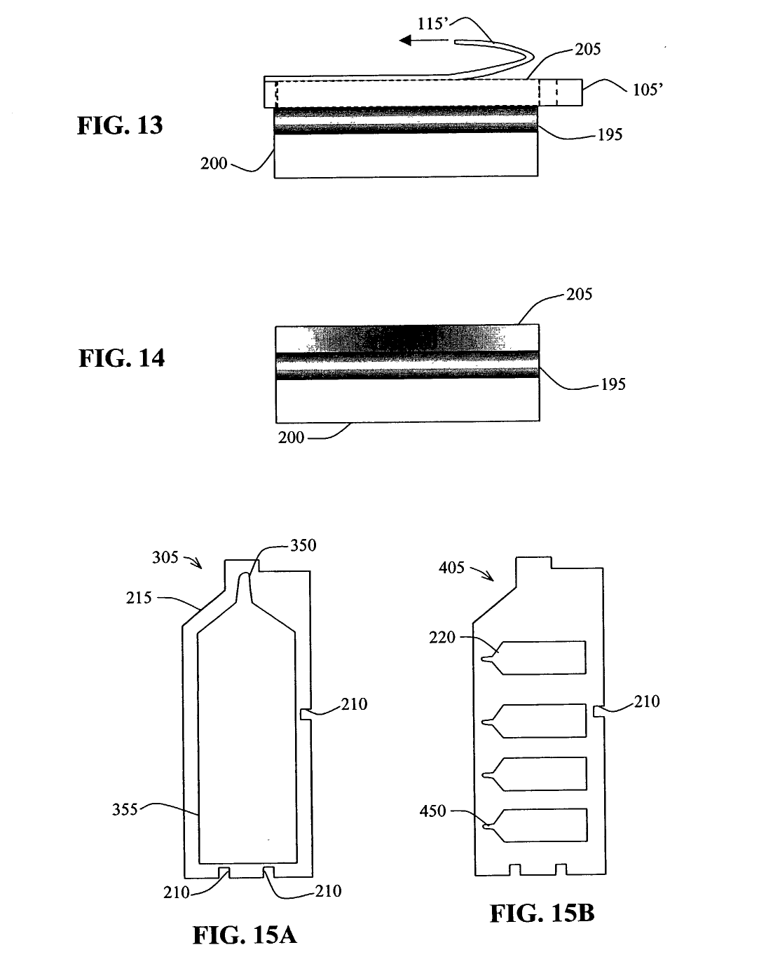

FIG. 13 and FIG. 14 illustrate an example of handling multiple gel matrices with a gel matrix mold 300. FIG. 13 shows the placement of a gel matrix 205 on top of the gel matrix 195, which is in the configuration depicted in FIG. 10. The gel matrix 205 may be handled with its corresponding gel matrix frame 105′ having a second plastic film 115′ and a first plastic film 110′ (not shown). As previously mentioned, the thickness of the gel matrix frame 105′ may be chosen according to the desired thickness of the gel matrix 205. For example, in cell-based assays a matrix gel 205 may carry nutrients for cells embedded in the gel matrix 195. The gel matrix 205 may be placed on top the gel matrix 195 to keep the cells alive. A relatively thick gel 205 may be used to allow for longer periods of time before changing the nutrient-laden matrix gel 205. In other embodiments, a relatively thin gel 205 may be cast and used to minimize assay time and lateral diffusion of assay agents.

The handling and placement of the gel matrix 205 is performed in substantially the same manner as discussed above with relation to the placement of the gel matrix 195 on top of the substrate 200. FIG. 14 depicts the gel matrix 195 sandwiched between the substrate 200 and the gel matrix 205. Hence, the gel matrix 195 can be reacted on one side with a substrate 200 and on the other side with a gel matrix 205. Instead of a gel matrix 205, the second gel matrix may be a membrane, for example.

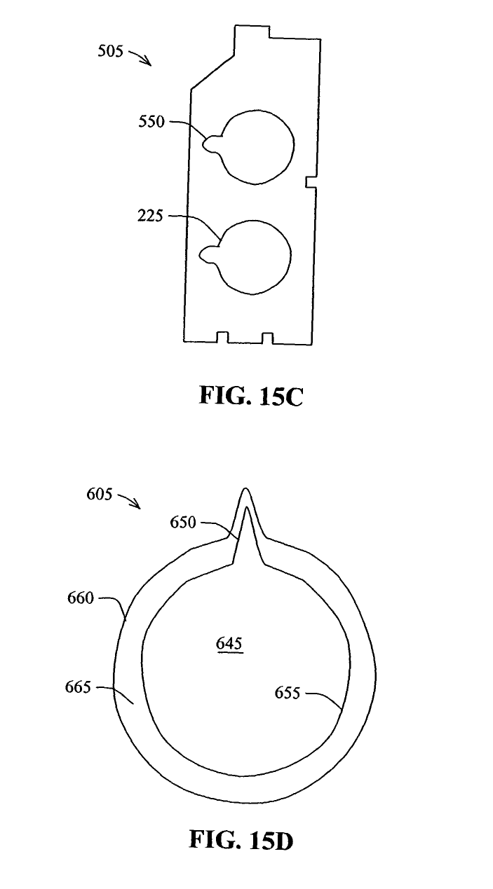

FIG. 15A shows one embodiment of a gel matrix frame 305. The gel matrix frame 305 may be configured with asymmetrical features such as bevel 215 to facilitate convenient and quick identification of the orientation of a gel matrix 195 that may be handled with the gel matrix frame 305. Additionally, the gel matrix frame 305 may have positioning features 210 to aid in positioning the gel matrix frame 305 in the gel casting assembly shown in FIG. 4, or to aid in position the gel matrix frame 305 on a substrate 200, for example. As with the gel matrix frame 105 previously discussed, the gel frame matrix 305 is configured with an opening 350 for receiving gel material in the inner space defined by the inner walls 355.

FIG. 15B depicts an alternative embodiment of a gel matrix frame 405. The gel matrices cast with the gel matrix mold 220 incorporated into the gel matrix frame 405 may be specially configured for use with well known laboratory slides for use with microscopes. Of course, the gel casting assembly (shown in FIG. 1 or FIG. 4) would be adapted to include a plate 120, for example, having multiple orifices 135 corresponding to orifices 450 of the gel matrix molds 220. FIG. 15C illustrates yet another embodiment of a gel matrix frame 505. In this embodiment, the gel matrix frame 505 incorporates substantially circular gel matrix molds 225 which may be configured for use with matrices cast in petri dishes, for example.

FIG. 15D shows an embodiment of gel matrix frame 605 that is substantially circular and may be used for casting relatively large circular gel matrix slabs. A gel matrix frame 605 in accordance with the invention preferably has inner walls 655 that define an inner space 645 for receiving a gel material therein. The gel matrix frame 605 further includes a flat surface 665 between the inner walls 655 and the outer walls 660 that may be compressed by the plates 120 and 125, for example. The gel matrix frame 605 may also include an opening 650 configured to cooperate with the orifices 135 and 140 of the plate 120 and first film 110, respectively, for receiving the gel material.

Thus, it will be apparent to the person of ordinary skill in the relevant technology that the geometry of a gel matrix frame, as may be used with the inventive gel casting, handling, and storage systems here described, need not be limited to any one particular shape or size. Moreover, the gel matrix frame described is not limited to be made of any particular material.

While the above detailed description has shown, described, and pointed out novel features of the invention as applied to various embodiments, it will be understood that various omissions, substitutions, and changes in the form and details of the systems or process illustrated may be made by those skilled in the relevant technology without departing from the spirit of the invention. The scope of the invention is indicated by the appended claims rather than by the foregoing description. All modifications which come within the meaning and range of equivalency of the claims are to be embraced within their scope.

What is claimed is:

1. A system for casting an assay matrix, comprising:
a first plate and a second plate positioned substantially parallel to one another for receiving in between the plates a mold for casting the assay matrix;
wherein the mold comprises a frame having a first side and a second side, and a first film that covers the first side of the frame;
wherein the mold forms at least part of a chamber for receiving a material for casting the assay matrix;
wherein a passageway is provided into the chamber that is suitable for introduction of the material for casting into the chamber; and
wherein the mold is removable from the plates.

2. The system of claim 1, wherein the mold further comprises a second film that covers the second side of the frame

3. The system of claim 2, wherein at least one of the first film or the second film is made of a plastic material.

4. The system of claim 1, wherein the passageway comprises a first orifice in the first plate and a second orifice in the first film, and wherein the first and second orifices are collocated.

5. The system of claim 1, wherein the frame comprises a plurality of inner walls and a plurality of outer walls.

6. The system of claim 5, wherein the inner walls form a closed contour.

7. The system of claim 6, wherein the frame comprises at least three inner walls.

8. The system of claim 1, wherein one of the plates is configured for changing the temperature of the material.

9. The system of claim 8, wherein one of the plates is configured for transferring heat to the to material.

10. The system of claim 8, wherein one of the plates is configured for cooling the material.

11. The system of claim 8, wherein at least one of the plates is a metallic plate.

12. The system of claim 8, further comprising a biasing structure urging at least one of the plates in the direction of the other plate.

13. The system of claim 4, further comprising a device for guiding the material through the first orifice, into the second orifice, and into the chamber.

14. The system of claim 10, further comprising a device for injecting the material into the device for guiding.

15. The system of claim 1, further comprising a device for delivering the material into the chamber, wherein the device applies a positive pressure to the material.

16. The system of claim 11, wherein the material is a liquid gel material.

17. A method of making an assay matrix, comprising:
providing two substantially parallel plates;
providing an assay matrix casting mold comprising a frame placed between two films, wherein the mold forms at least part of a chamber for receiving a material for casting the assay matrix;
placing the mold between the two plates, wherein the mold is removable from the plates;
providing a passageway into the chamber that is suitable for introduction of the material into the chamber; and
introducing the material into the chamber.

18. The method of claim 17, wherein at least one of the films and at least one of the plates each comprises an orifice for allowing the material into chamber.

19. The method of claim 17, further comprising applying pressure to at least one of the plates in the direction of the other plate.

20. The method of claim 17, further comprising changing the temperature of the material through at least one of the plates.

21. The method of claim 20, wherein changing the temperature comprises heating the material.

22. The method of claim 20, wherein changing the temperature comprises cooling the material.

23. The method of claim 20, wherein the material is a liquid gel material.

24. An apparatus for aiding in the casting and handling of an assay matrix, where plates are used for casting of the assay matrix, comprising:
a frame, having a plurality of inner and outer walls, positioned between two films;
wherein the plurality of inner walls and the two films are configured to form a chamber for receiving a material for casting an assay matrix;
a passageway into the chamber for injection of the material; and
wherein the frame is removable from the plates.

25. The apparatus of claim 24, wherein at least one of the films is configured with an orifice for receiving the material.

26. The apparatus of claim 24, wherein the frame is configured with an asymmetry to indicate orientation.

27. The apparatus of claim 24, wherein the frame is configured with one or more notches for positioning the frame in a device for casting the assay matrix.

28. The apparatus of claim 24, wherein the frame is configured with one or more notches for positioning the frame on a substrate.

29. The apparatus of claim 24, further comprising an assay matrix placed in the chamber.

30. The apparatus of claim 29, wherein the assay matrix comprises a gel matrix.

31. A system for performing an assay, comprising:
an assay matrix assembly comprising a gel slab laterally bounded by a frame and covered on at least a top side or a bottom side by a removable film; and
a planar substrate substantially sized and shaped to mate with the assay matrix assembly upon removal of the film such that diffusion of at least one assay agent can take place between the gel slab and the planar substrate.

32. The system of claim 31, wherein the gel slab contains at least one reagent for performing the assay.

33. The system of claim 32, wherein the substrate comprises an array of diffusible materials, the diffusible materials at least potentially capable of activity with the at least one reagent.

34. The system of claim 33, wherein the diffusible materials diffuse into gel slab.

35. The system of claim 34, wherein the diffusible materials are chemical compounds.
